(19) United States
(12) Patent Application Publication
(10) Pub. No.: US 2026/0089579 A1
(43) Pub. Date: Mar. 26, 2026

(54) EVOLVED PACKET SYSTEM FALLBACK AND VOICE OVER NEW RADIO CALL SAVE TECHNIQUES

(71) Applicant: Apple Inc., Cupertino, CA (US)

(72) Inventors: Alosious Pradeep Prabhakar, Singapore (SG); Vijay Venkataraman, San Jose, CA (US)

(73) Assignee: Apple Inc., Cupertino, CA (US)

(21) Appl. No.: 18/891,916

(22) Filed: Sep. 20, 2024

(51) Int. Cl. H04W 36/00; H04L 65/1016; H04L 65/1104

(52) U.S. Cl. CPC H04W 36/00222; H04L 65/1016; H04L 65/1104

(57) ABSTRACT

Techniques are provided for a voice over new radio techniques based on a fallback procedure. An example method can include causing a first tracking area update (TAU) request message to be transmitted to a first base station of a first network. The method can further include connecting with a second network based on performing an evolved packet system fallback (EPSFB) procedure. The method can include processing a message from the second network, the message indicating a dedicated bearer. The method can include generating a second TAU request message prior to processing a TAU accept message associated with the first TAU request, the second TAU request message to include evolved packet system (EPS) bearer information (EBI) having an indication of an Internet Protocol address for the dedicated bearer. The method can further include causing the second TAU request message to be transmitted to a second base station of the second network.

### TECHNICAL FIELD

The application relates to the technical field of communication networks, and in particular, to evolved packet system fallback and voice over new radio call save techniques in said communication networks.

### BACKGROUND

Cellular communications can be defined in various standards to enable communications between a user equipment and a cellular network. For example, a long-term evolution (LTE) network and Fifth generation mobile network (5G) are wireless standards that aim to improve upon data transmission speed, reliability, availability, and more.

### BRIEF DESCRIPTION OF THE DRAWINGS

FIG. 1 is an illustration of an example network environment, according to one or more embodiments.

FIG. 2 is an example flow chart for evolved packet system (EPS) fallback (FB) and voice over (Vo) new radio (NR) techniques, according to one or more embodiments.

FIG. 3 is an example process for a EPSFB and VoNR techniques, according to one or more embodiments.

FIG. 4 is an example process for a EPSFB and VoNR techniques, according to one or more embodiments.

FIG. 5 is an illustration of an example of a user equipment (UE), in accordance with some embodiments.

FIG. 6 is an illustration of an example of a network node, in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc., in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “base station” as used herein refers to a device with radio communication capabilities, that is a network component of a communications network (or, more briefly, a network), and that may be configured as an access node in the communications network. A UE's access to the communications network may be managed at least in part by the base station, whereby the UE connects with the base station to access the communications network.

Depending on the radio access technology (RAT), the base station can be referred to as a gNodeB (gNB), eNodeB (eNB), access point, etc.

The term “network” as used herein reference to a communications network that includes a set of network nodes configured to provide communications functions to a plurality of user equipment via one or more base stations. For instance, the network can be a public land mobile network (PLMN) that implements one or more communication technologies including, for instance, 5G communications.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component or asset within a computing or network environment, or a physical or virtual component within, accessible by, or available to a device, apparatus, circuitry, or component.

Resources could include, but are not limited to, memory space/usage, processor/CPU time, processor/CPU usage, processor and accelerator loads, hardware time or usage, electrical power, input/output operations, ports or network sockets, channel/link allocations, throughput, or workload units. A “hardware resource” may refer to compute, storage, or networking resources provided by physical hardware elements. A “virtualized resource” may refer to compute, storage, or networking resources provided by virtualization infrastructure to an application, device, or system. The term “communication resource” may refer to resources that are accessible by, or available to, computer devices/systems for transferring information over a channel of a communication network. For example, communication resources may include, but are not limited to, time/frequency resources, code resources, modulation resources, etc. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “3GPP Access” refers to accesses (e.g., radio access technologies) that are specified by 3GPP standards. These accesses include, but are not limited to, GSM/GPRS, LTE, LTE-A, 5G NR, or 6G. In general, 3GPP access refers to various types of cellular access technologies.

The term “Non-3GPP Access” refers to any accesses (e.g., radio access technologies) that are not specified by 3GPP standards. These accesses include, but are not limited to, WiMAX, CDMA2000, Wi-Fi, WLAN, or fixed networks. Non-3GPP accesses may be split into two categories, “trusted” and “untrusted.” Trusted non-3GPP accesses can interact directly with an evolved packet core (EPC) or a 5G core (5GC), whereas untrusted non-3GPP accesses interwork with the EPC/5GC via a network entity, such as an Evolved Packet Data Gateway or a 5G NR gateway. In general, non-3GPP access refers to various types on non-cellular access technologies.

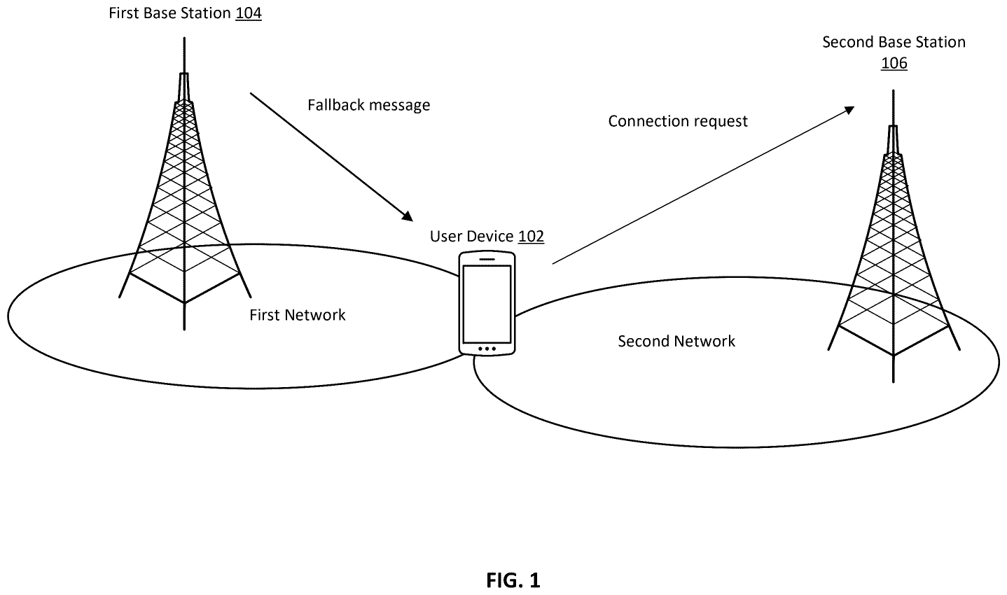

Evolved Packet System fallback (EPSFB) can include a mobility procedure, in which a network triggers a user equipment (UE) to change radio access from a first network (e.g., fifth generation (5G) network, standalone (SA) network) to a second network (e.g., fourth generation (4G)). This may occur, for example, when the first network cannot support the UE to complete a call or for data transmission. For example, a UE can attempt to use the first network to initiate a service, such as a voice over (Vo) new radio (NR) call service. The first network can perform a capability check to determine whether it can support the service for the UE. In the instance that the first network cannot support the service, the first network can determine that the UE can fallback to the second network. The first network can transmit information for the UE to connect with the second network. The UE can connect with the second network, and the second network can continue the service (e.g., a Vo long term evolution (LTE) service). When the UE completes using the service, it can reconnect with the first network. FIG. 1 is provided to illustrated various issues with an EPSFB procedure and a VoNR service.

FIG. 1 is an illustration of an example network environment, according to one or more embodiments. A UE 102 can be connected to a first network (e.g., 5G network, SA network) via the first base station 104. In some instances, the first network may determine that it cannot adequately provide services for the UE 102. For example, the UE 102 may send a service request for a VoNR service. The first network may perform a capability check and determine, for example, that it does not support VoNR, or is experiencing strained resources. The first base station 104 can transmit instructions for the UE 102 to connect with the second network (e.g., 4G network). The UE 102 can connect with the second network via the second base station 106. The UE 102 can use a VoLTE service via the second base station 106. Once the UE 102 has completed using the service, the UE 102 can reconnect with the first network via the first base station 104.

Various VoNR issues can occur between the UE 102 and a network. Four example issues are described below. The first two issues relate to VoNR involving a fallback from a first network (e.g., 5G network, SA network) to a second network (e.g., 4G network). The second two issues relate to VoNR for a UE connected to the first network.

The first issue relates to a tracking area update (TAU). In some instances, when the UE 102 is in a fallback procedure (e.g., an EPSFB procedure), it may need to perform a TAU. The UE 102 can use a TAU procedure to inform a network of a current TA. The UE 102 can transmit a TAU request message to the second base station 106 to update its location and register for a service with the second network. The TAU request message can include, for example, a UE identifier, a current TAU, and capability information.

The second base station 104 can respond with a TAU accept message that can confirm that the UE 102 has registered in the new TA within the second network. During the TAU procedure, the second network can determine Internet Protocol (IP) addresses for different services. In many instances, IP multimedia subsystem (IMS) services can require dedicated bearers with particular quality of service (QoS) parameters. The second network can establish the dedicated bearers for voice services. The second network can determine an IP address for the IMS services bearer, which is separate from a general internet access IP address. In general, the second network can provide this bearer context status information in a TAU accept message to the UE 102.

In some instances, the UE 102 may not receive the TAU accept message, or the UE 102 may not have properly decoded the TAU accept message prior to transmitting a subsequent TAU accept message. For example, after an expiration of time after transmitting a first TAU request message, the UE can transmit a second TAU request to the second network without having processed a TAU accept message. Furthermore, a dedicated bearer could be setup successfully by the second base station 104 prior to UE 102 sending the second TAU request. As a result, the second TAU request may not take dedicated evolved packet system (EPS) bearer information (EBI) into account. For example, the UE 102 may not include the dedicated bearer context status information in the second TAU request message based on not processing the TAU accept message. This can lead to a UE 102 experiencing a call drop. Furthermore, the second network can send a message (e.g., a session initiation protocol (SIP) 503-service unavailable) to the UE 102 due to a lack of bearer context status information in the second TAU request message. This can lead to increased latency for voice services.

A second issue can occur with respect to a provisional response acknowledgment (PRACK) message. In some instances, the UE 102 is connected to the first network (e.g., 5G network, SA network). The UE 102 can transmit a session initiation protocol (SIP) message (e.g., SIP INVITE message) to a party (e.g., first network) via the first base station 104. In response, the party can transmit a provisional SIP response (e.g., 1xx message) to the UE 102.

The SIP response can be an indication that a call setup is in progress. In instances that the UE 102 processes the SIP responses while connected to the first network, the UE 102 can transmit a PRACK message in response. The PRACK message can include, for example, an identifier, a sequence number, and other appropriate information. The first network can transmit an acknowledgment of receiving the PRACK message to the UE 102. The first network can then establish a call session and transmit a SIP response to the UE 102 indicating that the call has successfully been established.

However, in some instances, the first network can transmit a radio resource control (RRC) release message along with redirection information to cause the UE 102 to connect with a second network (e.g., a 4G network). This can be an issue if the UE 102 has transmitted the PRACK to the first network as it can disrupt the SIP message flow. For example, after transmitting the PRACK message to the first network, the UE 102 may have established a connection with the second network based on the RRCrelease message and redirection information. As the UE 102 is connected to the second network and having transmitted the PRACK message to the first network, it may not receive an acknowledgement message from the second network. In this situation, the UE may wait for a period of time (e.g., 2 seconds) and retransmit the PRACK message to the second network. For example, the UE 102 can start a retransmission timer upon transmitting the initial PRACK message to the first network and retransmit the PRACK message to the second network upon expiration of the timer. This can increase the call setup time. For example, the call set up time can be increased by 2-3 seconds.

It should be appreciated that particular networks are enabled to permit an exchange of information to determine that requirements are fulfilled prior to establishing a call. These preconditions for call establishment can ensure that the devices have the capabilities and resources are in place for establishing a call with an acceptable quality of service (QoS) before the media (e.g., voice, video) call is established. For example, the UE 102 can transmit a message (e.g., SIP INVITE) that indicates the preconditions (e.g., resources, capabilities, security protocols) for establishing a call with acceptable QoS. The UE 102 can receive a response (e.g., SIP response) that indicates whether one or more of the preconditions are met. In some instances, the techniques described herein can be implemented based on whether the network supports exchange preconditions for call establishment.

A third issue can occur when the UE 102 is in a radio resource control (RRC)-IDLE state and initiates a VoNR call service. For example, in some instances, the UE 102 can be triggered to enter an RRC-CONNECTED state by receiving a paging message from the network to indicate an incoming call or receive an indication of an input for making a call. In response to the receiving the paging message, the UE 102 can transmit a first service request to the first base station 104 to establish voice call over the first network. In some instances, the UE 102 can have previously connected to the first network and registered with an IP multimedia subsystem (IMS) for services (e.g., VoNR services). The first service request can be associated with a PDU session ID (PSI) to activate a first PDU session (e.g., IMS PDU session) or resume a previous IMS PDU session.

In some instances, triggering the UE 102 to enter the RRC-CONNECTED state can cause another application to request a second PDU session of another type (e.g., an internet PDU session). For example, user plane data can be initiated after transmitting the first service request. This can cause a race condition with the arrival of a service accept message from the first base station 104 and a subsequent transmission of a second service request for establishing the different PDU session. For example, almost immediately after processing a service accept message, the UE 102 can transmit the second service request message to establish an IMS PDU session and an internet PDU session. The first network may not honor the second service request as a data radio bearer (DRB) has just been setup for the IMS PDU session requested in the first service request. In this situation the UE 102 may have to wait until expiration of a timer (e.g., T3517) to send a third service request for establishing a PDU session. This can result in a longer than desirable setup time for establishing a VoNR call by the UE 102.

A fourth issue can relate to a dedicated QoS flow of a VoNR call. The first network can assign a QoS flow identifier (QFI) to a QoS flow within a PDU session to differentiate the VoNR flow from other flows. The dedicated QoS flow(s) can be configured with particular QoS characteristics for enabling a high quality call. After a VoNR call is completed, the first network can transmit a PDU Session Modification Request Message to the UE 102 to delete the dedicated QoS flows for the VoNR. However, in some instances, the UE 102 does not process the PDU Session Modification Request Message, or the first network erroneously does not send the dedicated QoS flows for VoNR to the UE 102.

In the instance that the UE 102 attempts to setup a subsequent Mobile Originated (MO)/Mobile Terminated (MT) VoNR call, the first network may transmit a PDU Modification Command with new dedicated QoS flows that are mapped to same QFI value as the previous dedicated QoS flows. In this instance, the UE 102 may identify the duplicate dedicated QoS workflows and send a PDU Session Modification Request to the first base station 104 to delete the old dedicated QoS flows. For example, the UE 102 can transmit a message with a cause code (e.g., Cause 83—Semantic Error in QoS Operation) to the first base station 104. However, in some instances, the first network, via the first base station 104, can transmit a PDU Session Reject message and UE's VoNR call fails.

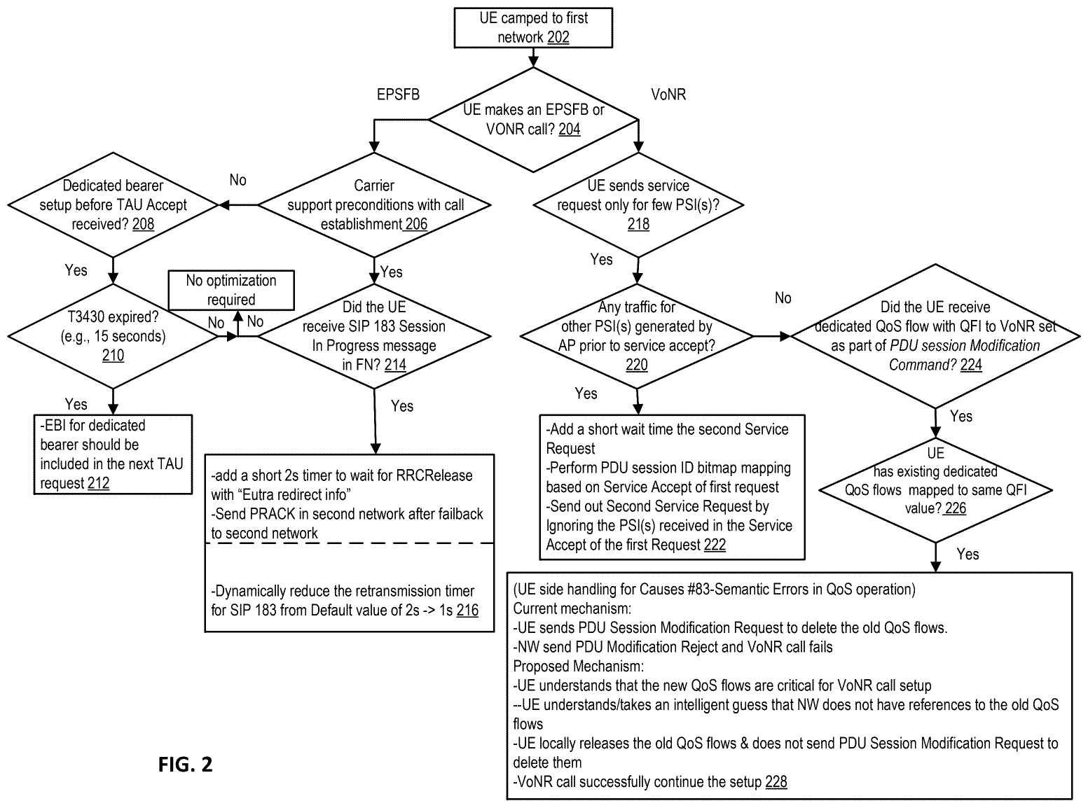

The embodiments herein provide techniques for addressing each of the above described issues. FIG. 2 is provided as a flow chart describing processes for various techniques for addressing the issues.

FIG. 2 is an example flow chart 200 for EPS fallback and VoNR techniques, according to one or more embodiments. At 202, a UE (e.g., UE 102) can be camped on a first network (e.g., 5G network, SA network). At 204, the UE can either follow a path for engaging in an EPSFB procedure and connecting with a second network (e.g., 4G network) or a path for making a VoNR call over the first network.

If the first network does not support exchanging preconditions for call establishment, the process can move to 208 related to above first issue. In this scenario, the UE may have transmitted a first TAU request message to a base station. The UE can start a timer (e.g., T3420) upon transmission of the TAU request message. At 208, the second network may have setup a dedicated bearer before the UE has processed a TAU accept message. At 210, the UE can determine whether the timer expired. Upon expiration of the timer, the UE can transmit a second TAU request message before having processed a TAU accept message from the base station at 212. The second TAU request message can include EBI for internet, IMS and dedicated bearer setup for voice. For example, the second TAU request message can include an indication of EBI 5, 6 & 7, with EBI 5 mapping to internet services, EBI 5 mapping to IMS services & EBI 7 mapping to the dedicated bearer setup for voice services. By providing the base station with the EBIs of default and dedicated bearers, the second network is less likely to drop the call due to the lack of EBI for the dedicated bearer. If at 210, the timer has not expired and the UE has processed the TAU accept message, the UE does not need to transmit the second TAU request message and no optimization is required.

If at 206, the first network does support exchanging preconditions for call establishment, the process can move to 214, which relates to the second issue described above. The UE can have transmitted a first PRACK while connected to the first network. At 214, the UE can determine whether it received an SIP message (e.g., SIP 183 Session in Progress message) in the first network. If the UE did not receive the SIP message in the first network, no optimization is required and the UE can continue to behave normally. If the UE did receive the SIP message in the first network, the UE can set a timer (e.g., 2 second timer) or add time to an existing timer (e.g., add 1 second to a 1 second timer) and wait for the first network to transmit an RRCrelease message with evolved universal terrestrial radio access (EUTRA) redirection information. Once the UE connects with the second network, and after expiration of the timer, the UE can transmit a PRACK to the second network and receive an SIP message in response. Another option can include the second network setting a reduced retransmission timer (e.g., 1 second timer) or reducing length of time of an existing retransmission timer (e.g., reducing the length from 2 seconds to 1 second), such that the UE receives the SIP message faster based on the reduced retransmission timer than without a reduced retransmission timer.

If at 204 a VoNR call is to be made over the first network, the process can proceed to 218. At 218 the UE can transmit a service request for establishing PDU session ID (PSI) (e.g., an IMS PDU session, an internet PDU session). At 220, the UE can determine whether any traffic (e.g., user plane traffic) is generated by an application processor (AP) prior to receiving a service response from the first network. If the UE determines that the traffic was generated prior to receiving the service response, the process can proceed to 222 which is related to the third issue described above. The UE can start a timer to add a wait time prior to transmitting a second service request. In this sense, the first network may not reject the second service request for being received within threshold interval of time as transmitting the service accept. Another option is that the UE can perform a PDU session ID bitmap mapping based on the service accept of the first service request. The UE can then transmit a second service request that ignores a PSI of the first service request. For example, if the first service request for a first PDU session type (e.g., IMS PDU session), the UE can determine to not request the first PDU session type in the second service request, and, for example, request another PDU session type (e.g., internet PDU session).

If no traffic was generated at 220, the process can proceed to 224. At 224, the UE can determine a QoS flow mapped to QFI was received (e.g., via a PDU Session Modification Command). The UE can then determine whether it has previously stored existing dedicated QoS flows mapped to the same QFI value at 226. If the answer is yes, the process can proceed to 228. At 228, the UE can locally determine to release the old QoS flows. Furthermore, the UE does not transmit a PDU Session Modification Request to the first base station to delete the QoS workflows. If the answer is no, the UE can behave normally with no optimization.

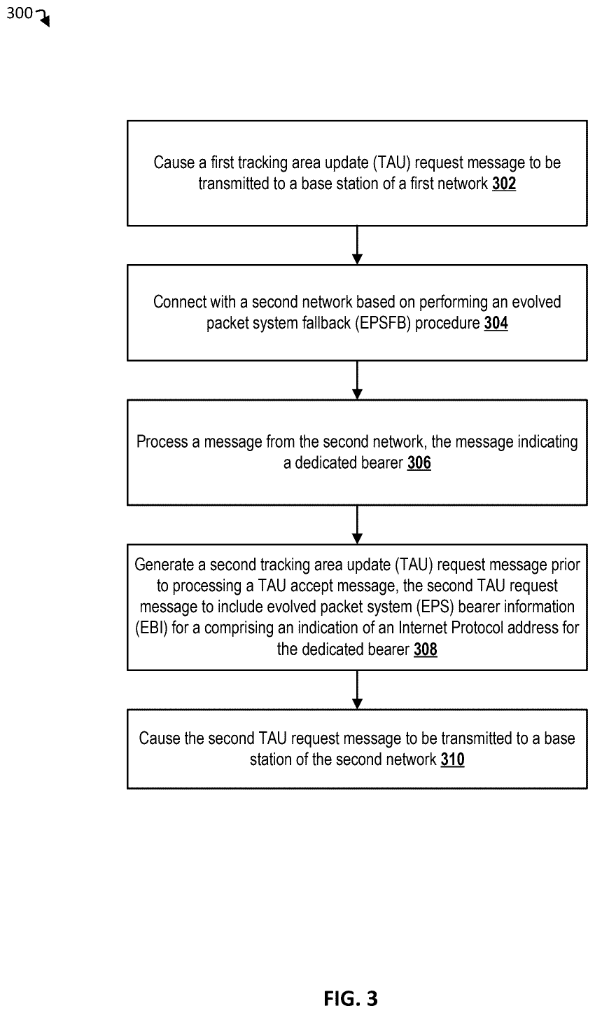

FIG. 3 is an example process 300 for a EPSFB and VoNR techniques, according to one or more embodiments. At 302, the process 300 can include an apparatus of a UE (e.g., 102) causing a first tracking area update (TAU) request message to be transmitted to a first base station (e.g., first base station 104) of a first network (e.g., 5G SA network). At some point the first network may determine that it cannot provide services to the UE and request that the UE fallback to a second network (e.g., 4G network). After the apparatus transmits the first TAU request message, a timer (e.g., T3430) can be started by the apparatus.

At 304, the process 300 can include the apparatus connecting with a second network based on performing an EPSFB procedure.

At 306, the process 300 can include the apparatus processing a message from the second network, the message indicating a dedicated bearer. The message can include an Activate Dedicated Bearer Request message. The message can be part of a protocol for managing a quality of service (QoS) for data transmission. In some embodiments, the dedicated bearer can be an EBI greater than EBI 6 (e.g., EBI 7).

At 308, the process 300 can include the apparatus generating a second tracking area update (TAU) request message prior to processing a TAU accept message from the first network. The second TAU request message to include EBI comprising an indication of an Internet Protocol address for the dedicated bearer. The second TAU request message can include the existence of IP addresses for multiple bearers, including EBI 5, EBI 6, and the EBI indicated in the message (e.g., EBI 7).

At 310, the process can include the apparatus causing the second TAU request message to be transmitted to a second base station of the second network. In some instances, the second TAU request message is transmitted after expiration of the timer and the apparatus not having received a TAU accept message.

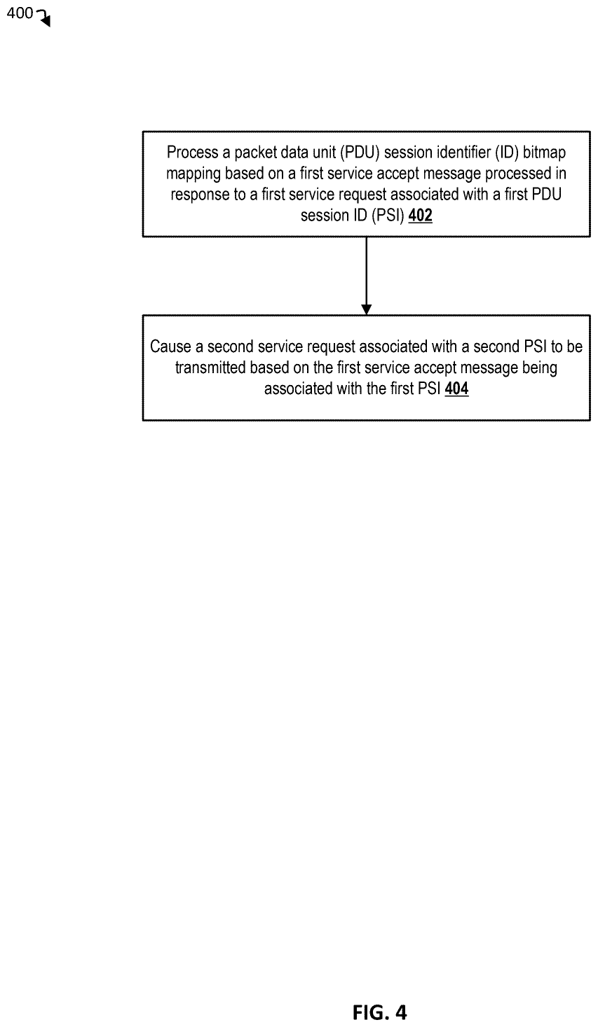

FIG. 4 is an example process 400 for a EPSFB and VoNR techniques, according to one or more embodiments. At 402, the process 400 can include an apparatus of a UE (e.g., UE 102) processing a PDU session ID bitmap mapping based on a first service accept message processed in response to a first service request associated with a first PSI.

At 404, the process 400 can include the apparatus of the UE causing a second service request associated with a second PSI to be transmitted based on the first service accept message being associated with the first PSI.

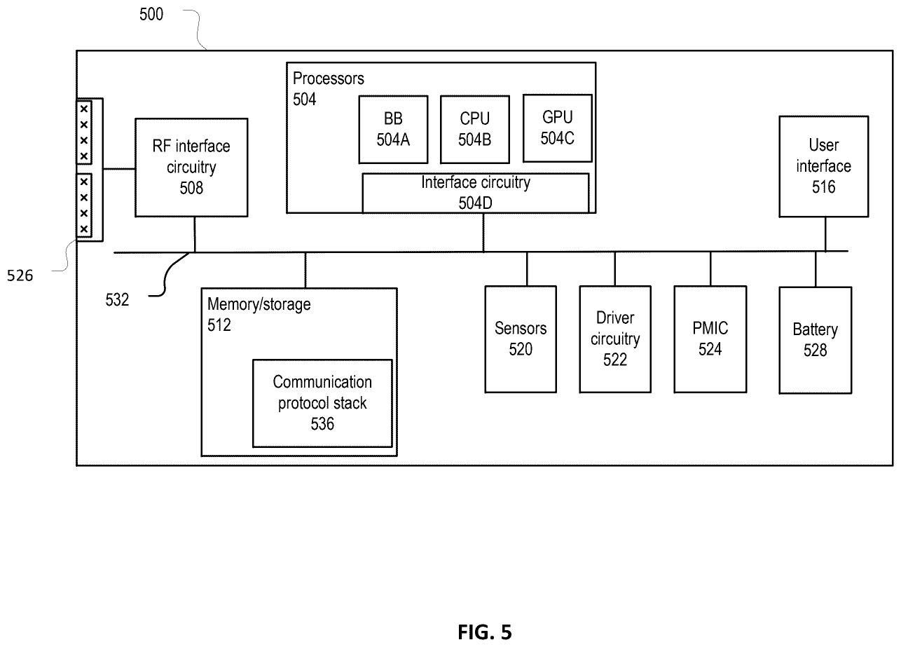

FIG. 5 illustrates a UE 500, in accordance with some embodiments. The UE 500 may be similar to and substantially interchangeable with UE 102 of FIG. 1.

The processors 504 may include processor circuitry such as, for example, baseband processor circuitry (BB) 504A, central processor unit circuitry (CPU) 504B, and graphics processor unit circuitry (GPU) 504C. The processors 504 may include any type of circuitry or processor circuitry that executes or otherwise operates computer-executable instructions, such as program code, software modules, or functional processes from memory/storage 512 to cause the UE 500 to perform delay-adaptive operations as described herein. The processors 504 may also include interface circuitry 504D to communicatively couple the processor circuitry with one or more other components of the UE 500.

In some embodiments, the baseband processor circuitry 504A may access a communication protocol stack 536 in the memory/storage 512 to communicate over a 3GPP compatible network. In general, the baseband processor circuitry 504A may access the communication protocol stack 536 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 508.

The baseband processor circuitry 504A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 512 may include one or more non-transitory, computer-readable media that includes instructions (for example, communication protocol stack 536) that may be executed by one or more of the processors 504 to cause the UE 500 to perform various delay-PRACH operations described herein.

The memory/storage 512 includes any type of volatile or non-volatile memory that may be distributed throughout the UE 500. In some embodiments, some of the memory/storage 512 may be located on the processors 504 themselves (for example, memory/storage 512 may be part of a chipset that corresponds to the baseband processor circuitry 504A), while other memory/storage 512 is external to the processors 504 but accessible thereto via a memory interface. The memory/storage 512 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 508 may include transceiver circuitry and a radio frequency front module (RFEM) that allows the UE 500 to communicate with other devices over a radio access network. The RF interface circuitry 508 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 526 and proceed to filter and amplify (with a low-noise amplifier) the signal. The signal may be provided to a receiver of the transceiver that down-converts the RF signal into a baseband signal that is provided to the baseband processor of the processors 504.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 526.

In various embodiments, the RF interface circuitry 508 may be configured to transmit/receive signals in a manner compatible with NR access technologies.

The antenna 526 may include antenna elements to convert electrical signals into radio waves to travel through the air and to convert received radio waves into electrical signals. The antenna elements may be arranged into one or more antenna panels. The antenna 526 may have antenna panels that are omnidirectional, directional, or a combination thereof to enable beamforming and multiple input, multiple output communications. The antenna 526 may include microstrip antennas, printed antennas fabricated on the surface of one or more printed circuit boards, patch antennas, or phased array antennas. The antenna 526 may have one or more panels designed for specific frequency bands including bands in FR1 or FR2.

The user interface 516 includes various input/output (I/O) devices designed to enable user interaction with the UE 500. The user interface 516 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 500.

The sensors 520 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 522 may include software and hardware elements that operate to control particular devices that are embedded in the UE 500, attached to the UE 500, or otherwise communicatively coupled with the UE 500. The driver circuitry 522 may include individual drivers allowing other components to interact with or control various input/output (I/O) devices that may be present within, or connected to, the UE 500. For example, driver circuitry 522 may include a display driver to control and allow access to a display device, a touchscreen driver to control and allow access to a touchscreen interface, sensor drivers to obtain sensor readings of sensors 520 and control and allow access to sensors 520, drivers to obtain actuator positions of electro-mechanic components or control and allow access to the electro-mechanic components, a camera driver to control and allow access to an embedded image capture device, audio drivers to control and allow access to one or more audio devices.

The PMIC 524 may manage power provided to various components of the UE 500. In particular, with respect to the processors 504, the PMIC 524 may control power-source selection, voltage scaling, battery charging, or DC-to-DC conversion.

A battery 528 may power the UE 500, although in some examples the UE 500 may be mounted deployed in a fixed location and may have a power supply coupled to an electrical grid. The battery 528 may be a lithium ion battery, a metal-air battery, such as a zinc-air battery, an aluminum-air battery, a lithium-air battery, and the like. In some implementations, such as in vehicle-based applications, the battery 528 may be a typical lead-acid automotive battery.

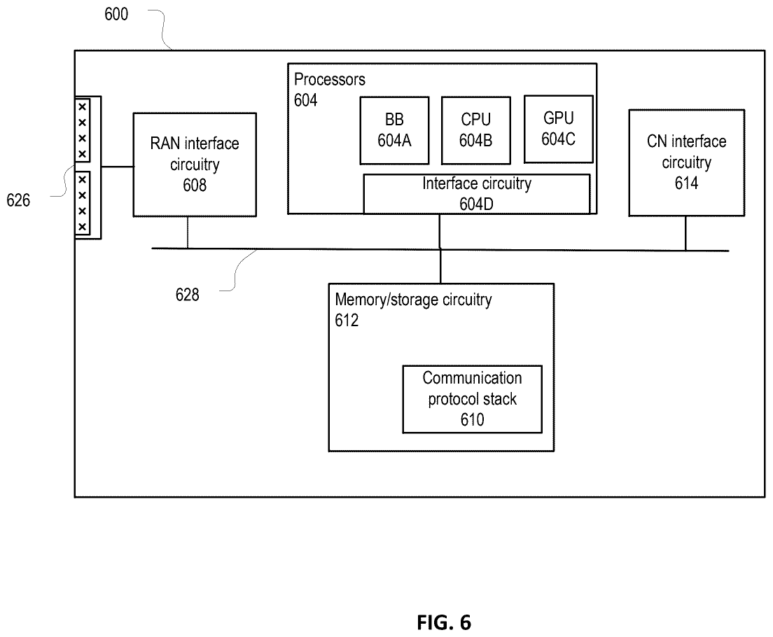

FIG. 6 illustrates a network device 600 in accordance with some embodiments. The network device 600 may be similar to and substantially interchangeable with base station or a device of the core network or external data network.

The network device 600 may include processors 604, RF interface circuitry 608 (if implemented as a base station), core network (CN) interface circuitry 614, memory/storage circuitry 612, and antenna structure 626.

The components of the network device 600 may be coupled with various other components over one or more interconnects 628.

The processors 604, RF interface circuitry 608, memory/storage circuitry 612 (including communication protocol stack 610), antenna structure 626, and interconnects 628 may be similar to like-named elements shown and described with respect to FIG. 5.

The processors 604 may include processor circuitry such as, for example, baseband processor circuitry (BB) 604A, central processor unit circuitry (CPU) 604B, and graphics processor unit circuitry (GPU) 604C. The processors 604 may include any type of circuitry or processor circuitry that executes or otherwise operates computer-executable instructions, such as program code, software modules, or functional processes from memory/storage circuitry 612 to cause the network device to perform delay-adaptive operations as described herein. The processors 604 may also include interface circuitry 604D to communicatively couple the processor circuitry with one or more other components of the network device 600.

The CN interface circuitry 614 may provide connectivity to a core network, for example, a 5th Generation Core network (5GC) using a 5GC-compatible network interface protocol such as carrier Ethernet protocols, or some other suitable protocol. Network connectivity may be provided to/from the network device 600 via a fiber optic or wireless backhaul. The CN interface circuitry 614 may include one or more dedicated processors or FPGAs to communicate using one or more of the aforementioned protocols. In some implementations, the CN interface circuitry 614 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### Examples

In the following sections, further example embodiments are provided.

Example 1 can include a method comprising: causing a first TAU request message to be transmitted to a first base station of a first network; connecting with a second network based on performing an EPSFB procedure; processing a message from the second network, the message indicating a dedicated bearer; generating a second TAU request message prior to processing a TAU accept message associated with the first TAU request, the second TAU request message to include EBI having an indication of an Internet Protocol address for the dedicated bearer; and causing the second TAU request message to be transmitted to a second base station of the second network.

Example 2 can include the method of example 1, wherein the dedicated bearer is associated with a voice service.

Example 3 can include the method of any of examples 1 or 2, further comprising: generating the TAU request message prior to receiving the TAU accept message or prior to properly decoding the TAU accept message.

Example 4 can include the method of any of examples 1-3, wherein the TAU request message is a first TAU request message and the method further comprises: starting a timer based on transmission of the first TAU request message; and causing the second TAU request message to be transmitted based on expiration of the timer.

Example 5 can include the method of any of examples 1-4, wherein the method further comprises: determining whether the network supports preconditions for call establishment, wherein the first TAU request message is transmitted based on whether the network supports preconditions for call establishment.

Example 6 can include an apparatus comprising: processor circuitry to perform any of the steps of examples 1-5; and interface circuitry coupled to the processing circuitry to enable communication.

Example 7 can include one or more non-transitory, computer-readable media having stored thereon a sequence of instructions that, when executed, cause processor circuitry to perform any of the steps of example 1-5.

Example 8 can in include an apparatus comprising: processor circuitry to: connect with a first network based on performing an EPSFB procedure, and cause a PRACK message to be transmitted to the first network based on processing a SIP message while connected to a second network; and interface circuitry coupled to the processing circuitry to enable communication.

Example 9 can include the apparatus of example 8, wherein the processor circuitry is further to: determine the first network supports preconditions for call establishment, wherein the PRACK message is transmitted to the first network rather than the second network based on said determination that the first network supports preconditions for call establishment.

Example 10 can include the apparatus of any of examples 8 or 9, wherein the processor circuitry is further to: start, based on processing the SIP message, a timer with a value that is based on an expected processing time of EUTRA information, wherein the PRACK message is transmitted based on expiration of the timer.

Example 11 can include an apparatus of any of examples 8-10, wherein the processor circuitry is further to: determine the first network supports preconditions for call establishment; and increase a value of a timer based on said determination that the first network supports preconditions for call establishment, wherein the PRACK message is transmitted based on expiration of the timer.

Example 12 can include the apparatus of any of examples 8-11, wherein a timing of processing the SIP message is based on a reduced retransmission timer associated with the first network.

Example 13 can include the method for performing any of the steps of examples 8-12.

Example 14 can include one or more non-transitory, computer-readable media having stored thereon a sequence of instructions that, when executed, cause processor circuitry to perform any of the steps of example 8-12.

Example 15 can include one or more non-transitory, computer-readable media having stored thereon a sequence of instructions that, when executed, cause processor circuitry to: process a PDU session ID bitmap mapping based on a first service accept message processed in response to a first service request associated with a first PSI; and cause a second service request associated with a second PSI to be transmitted based on the first service accept message being associated with the first PSI.

Example 16 can include the one or more non-transitory, computer-readable media of example 15, wherein the first service request is transmitted based on processing a paging message.

Example 17 can include the one or more non-transitory, computer-readable media of any of examples 15 or 16, wherein the first PSI is associated with IMS services.

Example 18 can include the one or more non-transitory, computer-readable media of any of examples 15-17, wherein the second PSI is associated with internet services.

Example 19 can include the one or more non-transitory, computer-readable media of any of examples 15-18, wherein the sequence of instructions, when executed, further cause processor circuitry to: start a timer based on transmitting the first service request, wherein the second service request is transmitted based on expiration of the timer.

Example 20 can include the one or more non-transitory, computer-readable media of any of examples 15-18, wherein the sequence of instructions, when executed, further cause processor circuitry to: start a timer with a value that is based on the first service request being associated with the first PSI and not the second PSI, wherein the second service request is transmitted based on expiration of the timer.

Example 21 can include an apparatus comprising: processor circuitry to perform any of the steps of examples 15-19; and interface circuitry coupled to the processing circuitry to enable communication.

Example 22 can include a method for performing any of the steps of examples 15-19.

Example 23 can include a method comprising: processing first quality of service (QoS) flows based on initiating a voice over new radio (VoNR) call; determining second QoS flows are stored in memory; and deleting the second QoS flows based on processing the first QoS flows.

Example 24 can include the method of example 23, wherein the method further comprises: determining that the first QoS flows are mapped to a QoS flow identifier (QFI) value; and determining that the second QoS flows are mapped to the QFI value, wherein the second QoS flows are deleted based on the first QoS flows and the second QoS flows being mapped to the QFI value.

Example 25 can include the method of example 24, wherein the method further comprises: determining whether to transmit a PDU session modification request based on the first QoS flows and the second QoS flows being mapped to a first QFI value.

Example 26 can include the method of any of examples 24 or 25, wherein the first QoS flows are processed based on a PDU session modification command.

Example 27 can include an apparatus comprising: processor circuitry to perform any of the steps of examples 25-26; and interface circuitry coupled to the processing circuitry to enable communication.

Example 28 can include one or more non-transitory, computer-readable media having stored thereon a sequence of instructions that, when executed, cause processor circuitry to perform any of the steps of example 25-26.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
causing a first tracking area update (TAU) request message to be transmitted to a first base station of a first network;
connecting with a second network based on performing an evolved packet system fallback (EPSFB) procedure;
processing a message from the second network, the message indicating a dedicated bearer;
generating a second TAU request message prior to processing a TAU accept message associated with the first TAU request, the second TAU request message to include evolved packet system (EPS) bearer information (EBI) having an indication of an Internet Protocol address for the dedicated bearer; and
causing the second TAU request message to be transmitted to a second base station of the second network.

2. The method of claim 1, wherein the dedicated bearer is associated with a voice service.

3. The method of claim 1, further comprising: generating the TAU request message prior to receiving the TAU accept message or prior to properly decoding the TAU accept message.

4. The method of claim 1, wherein the TAU request message is a first TAU request message and the method further comprises:
starting a timer based on transmission of the first TAU request message; and
causing the second TAU request message to be transmitted based on expiration of the timer.

5. The method of claim 1, wherein the method further comprises:
determining whether the network supports preconditions for call establishment, wherein the first TAU request message is transmitted based on whether the network supports preconditions for call establishment.

6. An apparatus comprising:
processor circuitry to:
connect with a first network based on performing an evolved packet system fallback (EPSFB) procedure, and
cause a provisional response acknowledgment (PRACK) message to be transmitted to the first network based on processing a session initiation protocol (SIP) message while connected to a second network; and
interface circuitry coupled to the processing circuitry to enable communication.

7. The apparatus of claim 6, wherein the processor circuitry is further to:
determine the first network supports preconditions for call establishment, wherein the PRACK message is transmitted to the first network rather than the second network based on said determination that the first network supports preconditions for call establishment.

8. The apparatus of claim 6, wherein the processor circuitry is further to:
start, based on processing the SIP message, a timer with a value that is based on an expected processing time of evolved universal terrestrial radio access (EUTRA) information, wherein the PRACK message is transmitted based on expiration of the timer.

9. The apparatus of claim 6, wherein the processor circuitry is further to:
determine the first network supports preconditions for call establishment; and
increase a value of a timer based on said determination that the first network supports preconditions for call establishment, wherein the PRACK message is transmitted based on expiration of the timer.

10. The apparatus of claim 6, wherein a timing of processing the SIP message is based on a reduced retransmission timer associated with the first network.

11. One or more non-transitory, computer-readable media having stored thereon a sequence of instructions that, when executed, cause processor circuitry to:
process a packet data unit (PDU) session identifier (ID) bitmap mapping based on a first service accept message processed in response to a first service request associated with a first PDU session ID (PSI); and
cause a second service request associated with a second PSI to be transmitted based on the first service accept message being associated with the first PSI.

12. The one or more non-transitory, computer-readable media of claim 11, wherein the first service request is transmitted based on processing a paging message.

13. The one or more non-transitory, computer-readable media of claim 11, wherein the first PSI is associated with Internet Protocol (IP) multimedia subsystem (IMS) services.

14. The one or more non-transitory, computer-readable media of claim 11, wherein the second PSI is associated with internet services.

15. The one or more non-transitory, computer-readable media of claim 11, wherein the sequence of instructions, when executed, further cause processor circuitry to:
start a timer based on transmitting the first service request, wherein the second service request is transmitted based on expiration of the timer.

16. The one or more non-transitory, computer-readable media of claim 11, wherein the sequence of instructions, when executed, further cause processor circuitry to:
start a timer with a value that is based on the first service request being associated with the first PSI and not the second PSI, wherein the second service request is transmitted based on expiration of the timer.

17. A method comprising:
processing first quality of service (QoS) flows based on initiating a voice over new radio (VoNR) call;
determining second QoS flows are stored in memory; and
deleting the second QoS flows based on processing the first QoS flows.

18. The method of claim 17, wherein the method further comprises:
determining that the first QoS flows are mapped to a QoS flow identifier (QFI) value; and
determining that the second QoS flows are mapped to the QFI value, wherein the second QoS flows are deleted based on the first QoS flows and the second QoS flows being mapped to the QFI value.

19. The method of claim 18, wherein the method further comprises:
determining whether to transmit a PDU session modification request based on the first QoS flows and the second QoS flows being mapped to a first QFI value.

20. The method of claim 17, wherein the first QoS flows are processed based on a PDU session modification command.
